(19) United States
(12) Patent Application Publication
(10) Pub. No.: US 2020/0059478 A1
(43) Pub. Date: Feb. 20, 2020

(54) CONTINUOUS HASH VERIFICATION

(71) Applicant: ARM IP LIMITED, Cambridge (GB)

(72) Inventor: Milosch MERIAC, Cambridge (GB)

(21) Appl. No.: 16/609,879

(22) PCT Filed: May 1, 2018
(86) PCT No.: PCT/GB2018/051161

§ 371 Date: Oct. 31, 2019

(30) Foreign Application Priority Data
May 4, 2017 (GB) 1707078.0

(51) Int. Cl. H04L 29/06; H04L 9/32

(52) U.S. Cl. CPC H04L 63/123; H04L 9/3242; H04L 9/3247

(57) ABSTRACT

There is described a method and data processing apparatus for verifying part or all of a downloading file, the file comprising a sequence of bytes, one or more bytes defining a block, the file having a final hash state calculated by a hash algorithm over the blocks in ascending order from first to last, each block having a starting hash state calculated by the hash algorithm, said method comprising: receiving the final hash state; receiving one or more blocks orderable in descending order starting from the last block; receiving, for each received block, the starting hash state for that block; calculating, for each received block, an ending hash state by running the hash algorithm from the starting hash state of the received block; confirming the starting hash state for each received block when the ending hash state is the same as the final hash state or a confirmed starting hash state; and flagging an error when an ending hash state does not match the final hash state or a confirmed starting hash state.

The present techniques relate to the detection of malicious changes against a conventional hash while downloading data and terminating the download in case modification of the data are detected during the download.

Early termination of a downloading file is particularly important when downloading firmware updates, as flashing the update requires considerable power and broken firmware updates can be used for depleting a device's battery for denial-of-service (DoS) reasons.

There is an ever-increasing number of data processing devices having processes and communication capabilities for interaction between themselves, network devices and services as part of the Internet of Things (IoT). For example, a heating system in a home may gather information from various temperature sensor devices and control activation of the heaters based on the gathered information. Another example, a factory pollution monitoring sensor device may gather information from various chemical sensors in a factory network and arrange maintenance via the Internet based on the gathered information. In another example, a fridge may gather information from products within the fridge and update a user as to stock levels and best before dates via the user's smart watch or smartphone. In another example, a door lock device configured to lock or unlock may communicate with an authorized device to receive control messages.

Such a network attached data processing device (called an IoT device henceforth) tends to have reduced security capabilities compared with a secure network computing system and as such tends to be vulnerable to third party attack. A third-party attacker may intercept a message destined for an IoT device and modify the message so to compromise and/or cause the IoT device to fail. It would be useful to be able to detect a modified message as early as possible so not to waste IoT device resources such as power and network bandwidth processing compromised messages.

According to a first technique, there is provided a method for verifying part or all of a downloading file, the file comprising a sequence of bytes, one or more bytes defining a block, the file having a final hash state calculated by a hash algorithm over the blocks in ascending order from first to last, each block having a starting hash state calculated by the hash algorithm, said method comprising: receiving the final hash state; receiving one or more blocks orderable in descending order starting from the last block; receiving, for each received block, the starting hash state for that block; calculating, for each received block, an ending hash state by running the hash algorithm from the starting hash state of the received block; confirming the starting hash state for each received block when the ending hash state is the same as the final hash state or a confirmed starting hash state; and flagging an error when an ending hash state does not match the final hash state or a confirmed starting hash state.

According to a second technique, there is provided a system for verifying part or all of a downloading file, the file comprising a sequence of bytes, one or more bytes defining a block, the file having a final hash state calculated by a hash algorithm over the blocks in ascending order from first to last, each block having a starting hash state calculated by the hash algorithm, said system comprising: a receiver for receiving the final hash state, receiving one or more blocks orderable in descending order starting from the last block, and receiving, for each received block, the starting hash state for that block; and a verifier for calculating, for each received block, an ending hash state by running the hash algorithm from the starting hash state of the received block, for confirming the starting hash state for each received block when the ending hash state is the same as the final hash state or a confirmed starting hash state, and for flagging an error when an ending hash state does not match the final hash state or a confirmed starting hash state.

Preferably, when the ending hash state does not match the final hash state or a confirmed starting hash state, the method and system further comprise ending the download and/or requesting retransmission of the download.

Embodiments will be described with reference to the accompanying figures of which:

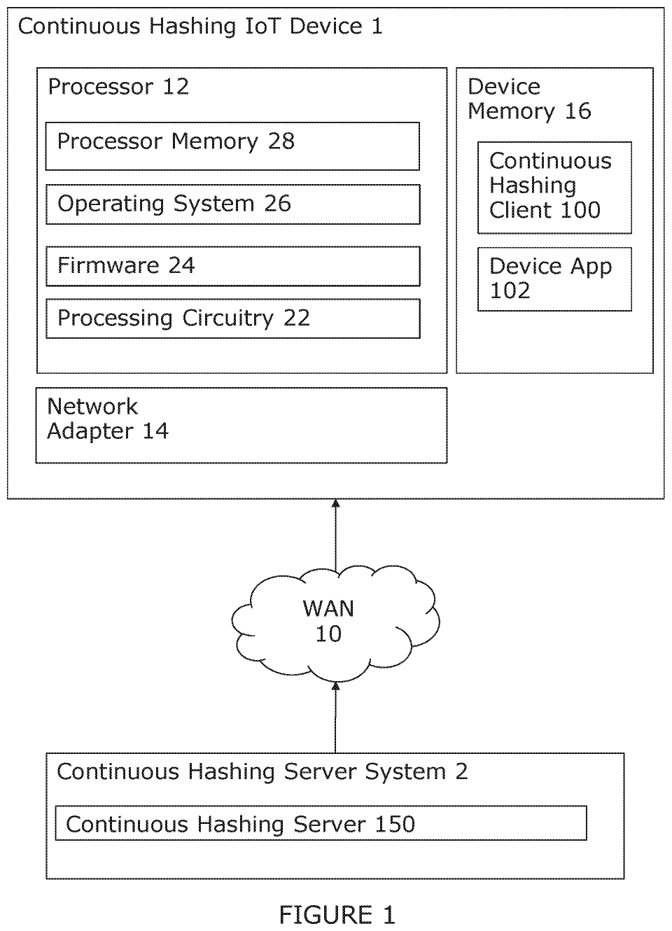

FIG. 1 is a deployment diagram for continuous hashing Internet of Things (IoT) device of a present embodiment;

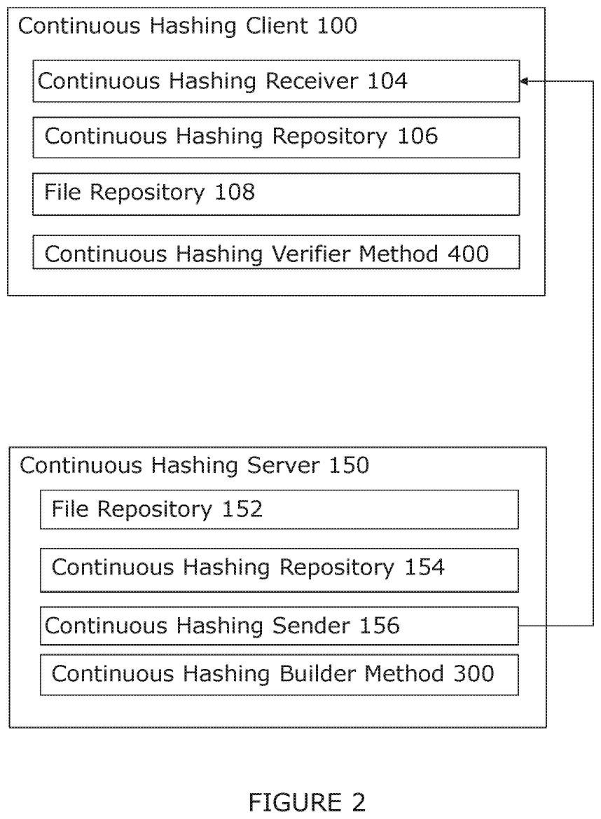

FIG. 2 is a component diagram of a continuous hashing client and continuous hashing server according to the present embodiment;

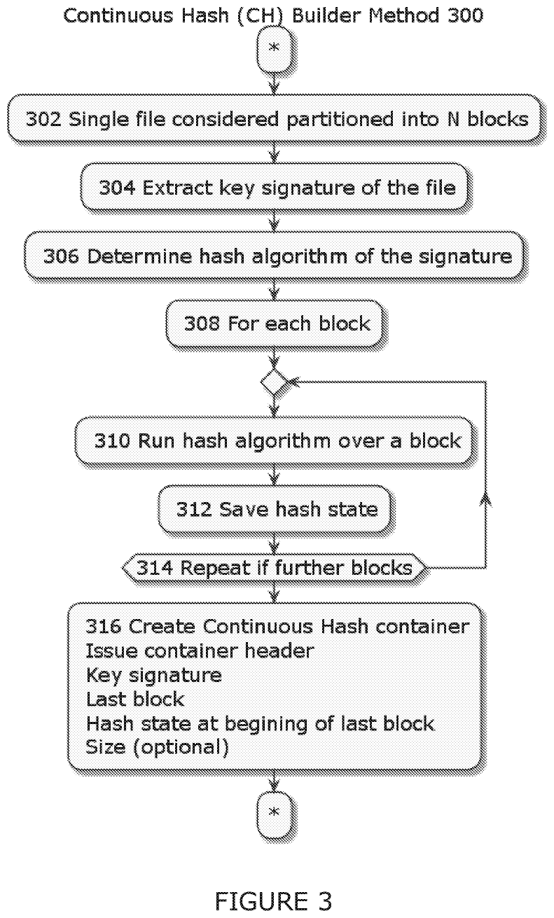

FIG. 3 is a diagram of a continuous hashing builder method according to the present embodiment;

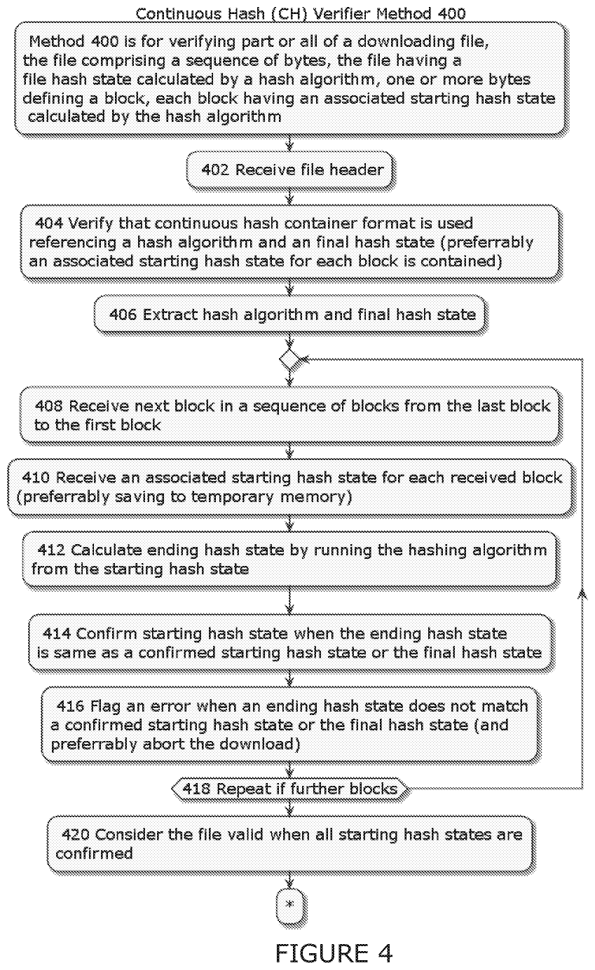

FIG. 4 is a diagram of a continuous hashing verifier method according to the present embodiment;

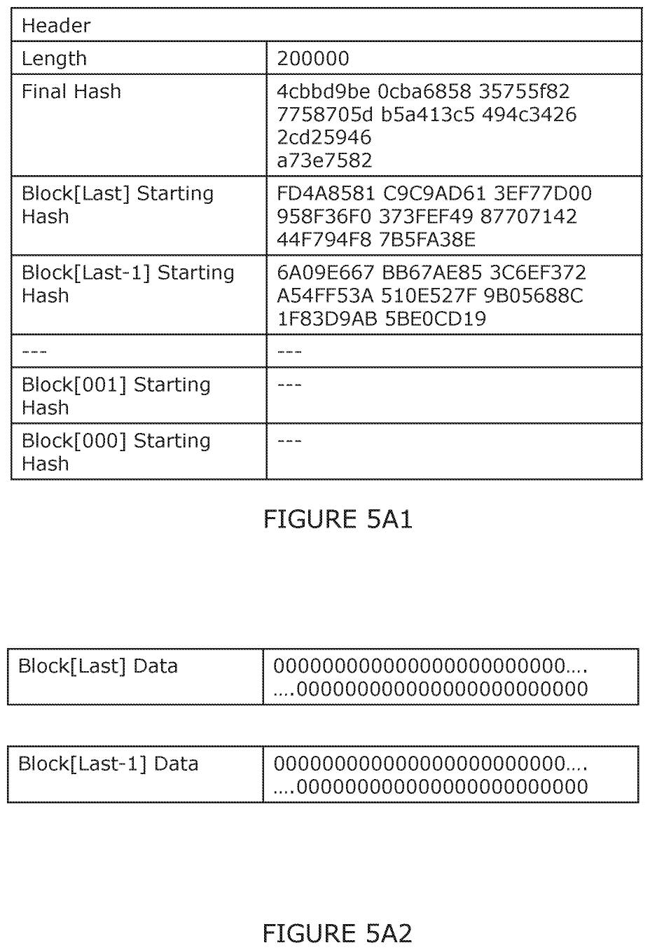

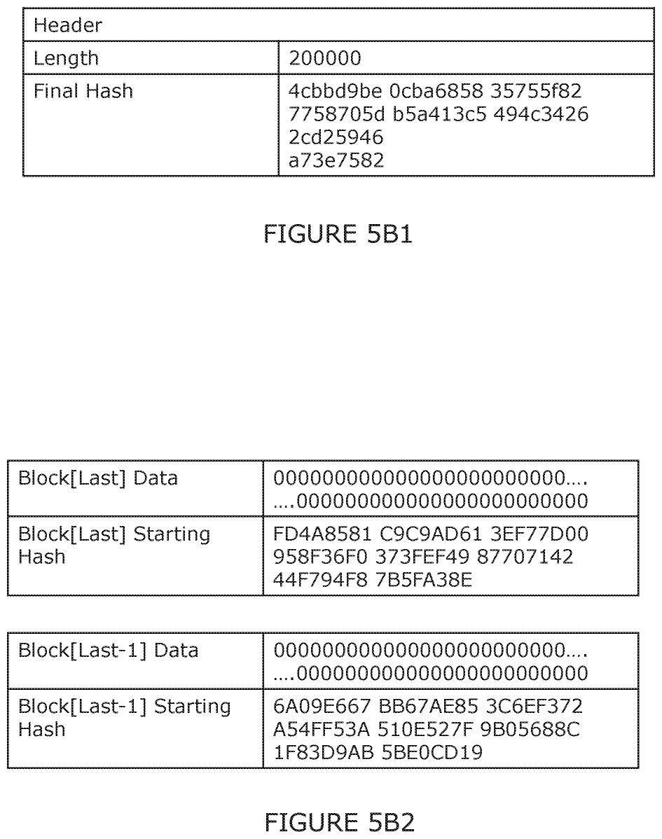

FIGS. 5A1 and 5A2 are schematic diagrams of an example file container and data packets of the present embodiment;

FIGS. 5B1 and 5B2 are schematic diagrams of an example file container and data packets of another embodiment; and

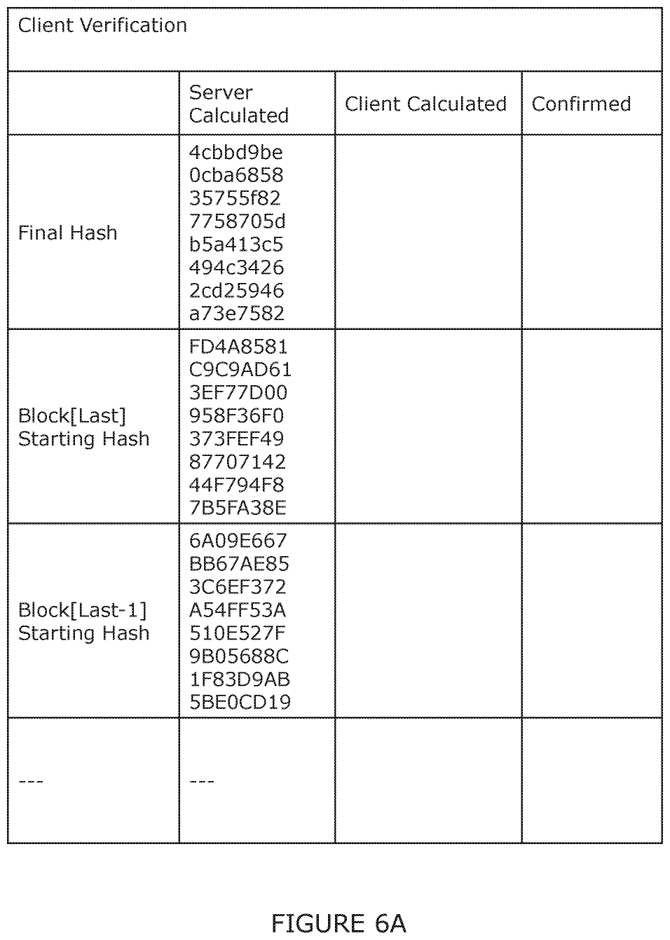

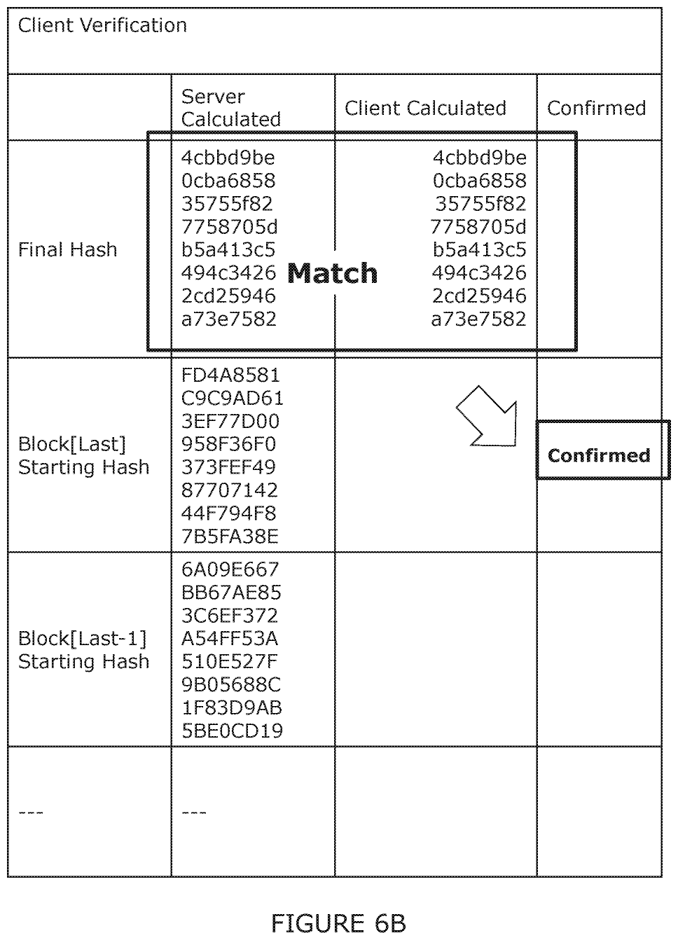

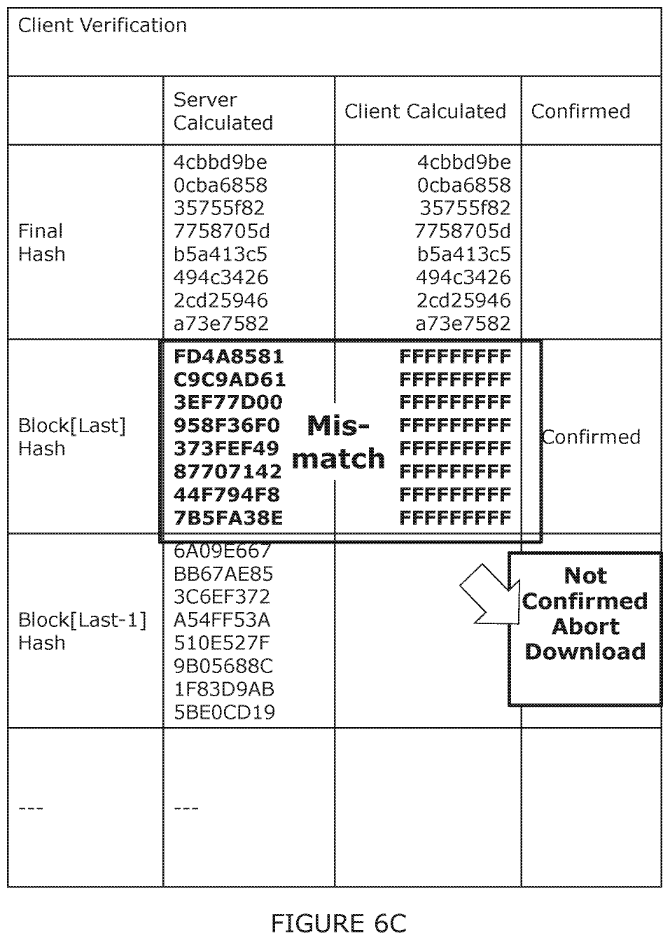

FIGS. 6A, 6B and 6C are schematic state diagrams of the example of FIG. 5A1.

Referring to FIG. 1, an example deployment for a computer implemented continuous hashing internet of things (IoT) device 1 embodiment is described. This and other embodiments can be applied over third party signed data, enabling block by block verification of that data during download without trusting the cloud or adding additional signatures. The embodiments can be also applied over existing tools like public private key signed attachments for trusted decoding/displaying while downloading an attachment. The embodiments additionally enable trusted serving log file entries from an untrusted cloud infrastructure in reverse order.

Continuous hashing IoT device 1 is operational with numerous other general purpose or special purpose computing system environments or configurations. Examples of well-known computing processing systems, environments, and/or configurations that may be suitable for use with continuous hashing IoT device 1 include, but are not limited to, gateways, routers, personal computer systems, server computer systems, thin clients, thick clients, hand-held or laptop devices, multiprocessor systems, microprocessor-based systems, set top boxes, programmable consumer electronics (smartphones, smart watches, tablets), network PCs, minicomputer systems, mainframe computer systems, and distributed computing environments that include any of the above systems or devices.

Continuous hashing IoT device 1 may be described in the general context of a computer system and a computer system on a chip (SoC). Such a computer system comprises executable instructions, such as program modules, being executed by a computer processor. Generally, program modules may include: routines; programs; objects; components; logic; and data structures that perform tasks or implement abstract data types.

Continuous hashing IoT device 1 is connected through a wide area network (WAN) 10 to continuous hashing server system 2. Any other type of network can be used including a low power wireless network. WAN 10 is typically a wired network such as the Internet.

Continuous hashing IoT device 1 comprises: processor 12; network adapter 14; and device memory 16.

Processor 12 is for loading machine instructions from device memory 16 and for performing machine operations in response to the machine instructions. Such machine operations include: performing an operation on a value in a register (for example arithmetical or logical operations); moving a value from a register to a memory location directly and vice versa; and conditional or non-conditional branching. A typical processor can perform many different machine operations. The machine instructions are written in a machine code language which is referred to as a low-level computer language. A computer program written in a high-level computer language (also known as source code) needs to be compiled to a machine code program (also known as object code) before it can be executed by the processor. Alternatively, a machine code program such as a virtual machine or an interpreter can interpret a high-level language (such as C) in terms of machine operations.

Network adapter 14 is for enabling communication between the continuous hashing IoT device 1 and network devices.

Device memory 16 comprises modules. A first module is a continuous hashing client 100 configured to carry out the functions of the preferred embodiment and a second module is a device application 102 for carrying out the particular device application. Device application 102 is not described further since the embodiments are relevant to any device function that might download a file such as a firmware update. In the present embodiment, modules are loaded from the device memory 16 into processor memory 28. Further program instruction modules that support the preferred embodiment but are not shown include firmware, boot strap program, and support applications.

Processor 12 comprises: processing circuitry 22; firmware 24; operating system 26; and processor memory 28.

Processing circuitry 22 is for processing instructions and comprises: fetch circuitry for fetching instructions; decode circuitry for decoding instructions; and execution circuitry for executing instructions (not shown). Data and program code stored in device memory 16 are accessible to processing circuitry 22.

Firmware 24 is an operating kernel program for running every other process and environment. Firmware 24 can be embodied in circuitry or program instructions in processor memory 28.

Operating system 26 is the basic system for loading and executing program modules including device applications and the continuous hashing client 100. Operating system 26 can be embodied in circuitry or program instructions in processor memory.

Processor memory 28 provides the execution environment for processor 12 and space for the program instructions for the firmware 24 and operating system 26.

Continuous hashing server system 2 is similarly operational with numerous other general purpose or special purpose computing system environments or configurations and is typically a computer server system. Continuous hashing server system 2 comprises similar components to the continuous hashing client 1 but these are not shown nor described. However, core functionality for the continuous hashing server system 2 exist in a computer module labelled continuous hashing server 150 described below.

Referring to FIG. 2, continuous hashing server 150 is for sending a file to continuous hashing client 100.

Continuous hashing server 150 comprises: file repository 152; continuous hashing repository 154; continuous hashing sender 156; and continuous hashing builder method 300.

File repository 152 is for storing a file for downloading to the client.

Continuous hashing repository 154 is for storing a header and hash states of blocks of the file.

Continuous hashing sender 156 is for sending the header, hash states, and data blocks to the continuous hashing client 100. There are two types of header: type A where the intermediate hash states are contained within the header and type B where the header only contains the final hash and each intermediate hash state is bundled with an associated data block. In both cases, the data block are sent in reverse order and confirmed from last to first.

Continuous hashing builder method 300 is for performing a build aspect of the embodiment as described below.

Continuous hashing client 100 comprises: a continuous hashing receiver 104; a continuous hashing repository 106; a file repository 108; and a continuous hashing verifier method 400.

Continuous hashing receiver 104 is for receiving a file header, data blocks and hash states from the continuous hashing server 150. In a firewall embodiment, continuous hashing receiver 104 is also for receiving each block and forwarding them to another device, optionally with an individual confirmation. Such an embodiment is transparent in that it invisibly verifies a download and will only become visible by generating new messages on their own in case of halting a download. In that halting case, they would create cancel requests to both sides of the communication (TCP reset ‘RST’ etc.) and stop forwarding any associated packets in future to terminate this download.

Continuous hashing repository 106 is for storing the file header, data blocks and hash states.

File repository 108 is for storing confirmed (and optionally not confirmed) data blocks.

Continuous hashing verifier method 400 is for performing a verification aspect of data blocks against the final and subsequent intermediate hash states as the data blocks are received from last to first as described below.

Referring to FIG. 3, continuous hash (CH) builder method 300 comprises steps 302 to 316.

Step 302 is for defining N blocks in a sequence from a single file (where ‘N’ may be one or more).

Step 304 is for extracting key signature of the file.

Step 306 is for determining the hash algorithm of the signature.

Step 308 is for defining a loop for starting with the first block as the current block and ending with the last block.

Step 310 is for running the hash algorithm over the current block to create a hash state. The number of blocks and/or the size of the blocks can be chosen to reduce the size of the hash state. For instance, multiples of 64 work well with SHA256 hashing algorithm.

Step 312 is for saving the hash state of the current block.

Step 314 is for repeating from step 310 with the current block set to the next block if there are further blocks.

Step 316 is for creating a continuous hash container comprising: the hashing algorithm used; the file hash state; optionally the hash states at beginning of the blocks; and optionally the size of the file. The container can suppress the starting hash state as it is normally the same for a given hash algorithm. A type A header contains all the intermediate hash states. A type B header contains a final hash or a reference to a final hash and where each intermediate hash is sent with an associated data block. In another embodiment, the static case for creation of a container file (for HTTP download etc.) comprises: splitting the file into N blocks (say 1 k); extracting a pre-existing public key signature of the file; determining the hash-algorithm of the signature; running that signature algorithm over the whole file; whenever a block boundary is crossed, remembering the running state of the hash; and creating a new file container with structure including: issue container header; pre-existing 3rd-party signature block; and the last block and the hash-state at the start of the block.

Referring to FIG. 4, a method of an embodiment is described with respect to steps 402 to 420 below. The method is for verifying part or all of a downloading file, the file comprising a sequence of bytes, one or more bytes defining a block, the file having a file hash state calculated by a hash algorithm over the blocks in ascending order from first to last, each block having an associated starting hash state calculated by the hash algorithm. Ascending and descending describe an order from first to last for creating a hash and a reversing of the order from last to first respectively to verify the hash. Other embodiments are envisaged having a sequential ordering of blocks for hashing purposes and subsequent reversing of that order for verifying the hash.

Step 402 is for receiving file header that is a type of container.

Step 404 is for verifying that continuous hash container format is used referencing a hash algorithm and a final hash state. Preferably an associated starting hash state for each block is contained but in other embodiments the associated starting hash can be sent separately or with each block. Preferably the final hash state is contained in the file header but in other embodiments a final hash state may be associated with the file header. For instance, the final hash state can be a signature created with a private key (for example an RSA signature). In such an embodiment, the final hash state is received as part of a signature to verify a sender of the file rather than in a container associated with the file and signature. The final hash state may be a finalized hash state after a further finalizing step has been applied.

Step 406 is for extracting the hash algorithm and the final hash state preferably from the container or a reference or an association with the file header. A finalizing hash algorithm may also be extracted.

Step 408 is for receiving the next block in a sequence of blocks from the last block in the sequence to the first block.

Step 410 is for receiving an associated starting hash state for each received block. Preferably the block and associated starting hash state are saved to temporary memory.

Step 412 is for calculating an ending hash state by running the hash algorithm from the starting hash state.

Step 414 is for confirming the associated starting hash state when the ending hash state is same as a confirmed starting hash state or the final hash state.

Step 416 is for flagging an error when an ending hash state does not match a confirmed starting hash state or the final hash state and preferably for subsequently aborting the download.

Step 418 is for repeating if there are further blocks. An indication of the size of the file may be contained in the container so that it is known when all the blocks have been received. In some embodiments, receiving a partial file uninterrupted from the end of the file is acceptable as long as it is uninterrupted from then end. For instance, when an email contains two parts (say a text part and an html part) and one of those parts is all that is needed then the whole file does not need to be received. Step 418 is also for going to step 420 if no further blocks are sent.

Step 420 is for considering the file as valid when all starting hash states are confirmed. The preferred embodiment makes the whole file available when the file is confirmed. Terminating the verification of all blocks without terminating early is one example of considering the file as valid. All successfully verified blocks are considered valid and a file can be considered partially valid up to the invalid block.

The blocks are orderable in descending order from the last block to the earliest block that is to be verified so that in a file comprising a sequence of blocks: B1, B2, B3; the blocks need to be orderable from B3 descending to B2 and B1 even if they were received in a different or random order (for example: B2, B1, B3) For example, in a mesh network receiving a broadcasted firmware image and especially a deep mesh node, broad packets would most likely arrive out of order. Each node would have a window of expected packets stored in SRAM. Verification would still have to be an uninterrupted chain from the last block to the earliest block and the system would only store uninterrupted verified blocks into the final location.

In a further symmetric crypto hash embodiment, the file is hashed using a HMAC algorithm. A public key signature is not needed in this special case. The intermediate hash states therefore must be calculated using the same HMAC with the same secret. To allow continuous reverse verification of such a file, the verification algorithm also requires the shared secret that was used for calculating the intermediate hashes. As for the other embodiments, the option exists that each transmitted associated hash state is finalized individually —optionally by using the file position at the point of each blocks hash finalisation.

In a modified embodiment, the verifying the file comprises: downloading the container over a network; verifying that the container format is used; receiving the signature, verifying and extracting the expected final hash state (MAC state or SHA256 for example); receiving the next block; receiving the expected MAC state at the start of the next block; using the MAC state as a start, calculating a MAC over the remaining bytes, finalizing and compare against the expected end from the signature, if matching then continuing with next block, if not matching then indicating an error and not forwarding that block to the user of the API; repeating until a complete image is downloaded. In subsequent blocks, a MAC only needs to be calculated for the next MAC state and if these match then that block is valid.

In a dynamic embodiment, a log file API signature is updated per request but the pre-calculated MAC states for the blocks before will not be different so can be part of the stored log file. The log file analysis tool can seek back into older and older log file entries, by calculating the MAC back block by block. For each block the downloader can be confident of its integrity. A network infrastructure cannot do anything about tampering with the signed log file. The log process will issue on a per-log-entry or per-block basis signatures for the tail. The network infrastructure can replace the previous signature atomically by later signatures.

Another dynamic case would be to provide a protocol or API around signed content delivery network (CDN) files like firmware update images. The MAC states for the whole image can be pre-calculated by the CDN and the file is served in reverse order to the downloader, by interleaving that with the pre-calculated MAC states, the downloader can verify the image while downloading.

Referring to FIG. 5A1, an example file container (type A) of the present embodiment comprises: the length of the file; a final hash; and the starting hashes of the bock [Last] to [001] The length of the file in the example is 200,000 bytes. The final hash is 4cbbd9be 0cba6858 35755f82 7758705d b5a413c5 494c3426 2cd25946 a73e7582. The starting hash of the last bock [Last] is FD4A8581 C9C9AD61 3EF77D00 958F36F0 373FEF49 87707142 44F794F8 7B5FA38E. The starting hash of the first block [Last-1] is 6A09E667 BB67AE85 3C6EF372 A54FF53A 510E527F 9B05688C 1F83D9AB 5BEOCD19. The starting hashes of subsequent blocks are not shown.

Referring to FIG. 5A2, example data blocks for a file container (type A) of the present embodiment comprises just the data block (in this case a plain set of zero bytes). Packaging data for the data block is not shown and the point to note is that any associated hash is not included with the data as it should have been included with the file header.

Referring to FIG. 5B1, a different example file container (type B) comprises: the length of the file; and a final hash (but not intermediate hashes as in type A). As for type A, the length of the file in the example is 200,000 byte and the final hash is 4cbbd9be 0cba6858 35755f82 7758705d b5a413c5 494c3426 2cd25946 a73e7582.

Referring to FIG. 5B2, the first two data packets sent and received for the example file of the present embodiment are block[Last] and block[Last−1].

The data packet for block[Last] comprises: the last data block and the starting hash of the last bock [Last]. This hash is FD4A8581 C9C9AD61 3EF77D00 958F36F0 373FEF49 87707142 44F794F8 7B5FA38E. Packaging data for the data packet is not shown and the point to note is that the associated hash is included with the data and not with the file header.

The data packet for the block [Last−1] comprises the data (all zeros) and a starting hash of 6A09E667 BB67AE85 3C6EF372 A54FF53A 510E527F 9B05688C 1F83D9AB 5BEOCD19. The starting hashes of subsequent blocks are not shown.

Referring to FIGS. 6A, 6B and 6C, state diagrams of the example of FIG. 5A1 are described.

FIG. 6A shows the state of the client having received the header file of from the example and loaded the header into a data structure comprising a column for client calculated values and a column for confirmed values for the final hash and the starting hashes. The header is loaded and no values have been calculated or confirmed.

FIG. 6B shows the next state. The starting hash for the last block [Last] FD4A8581 C9C9AD61 3EF77D00 958F36F0 373FEF49 87707142 44F794F8 7B5FA38E is used to calculate (step 412) a final hash as 4cbbd9be 0cba6858 35755f82 7758705d b5a413c5 494c3426 2cd25946 a73e7582. This is confirmed (step 414) as matching the received final hash state and the last block is confirmed in the confirmed column. At the least the last block of bytes in the downloaded has been validated.

FIG. 6C shows the next state. The starting hash for the second to last block [Last−1] 6A09E667 BB67AE85 3C6EF372 A54FF53A 510E527F 9B05688C 1F83D9AB 5BE0CD19 is used to calculate (step 412) a hash but something is wrong with the data as sent (not shown) and the hash is calculated as FFFFFFFFF FFFFFFFFF FFFFFFFFF FFFFFFFFF FFFFFFFFF FFFFFFFFF FFFFFFFFF FFFFFFFFF. Since this does not match the starting hash of block [Last] then the last but one block [Last−1] is not confirmed (step 416). The data of this block is rejected (and subsequent blocks also are rejected) and the download is aborted at this stage. Data blocks confirmed before this stage can be retained. On subsequent downloads, these verified blocks can be skipped.

Examples of the usage of continuous hashing embodiments include: firmware downloading; log file application interfaces (APIs); partial downloading of files; backwards compatibility; anonymous content delivery networks; and hardware engines.

When downloading firmware using continuous hashing, a device can terminate the download of a firmware image as soon as it stumbles over a modification from the originally signed image during the download. In case of a firewall performing an on-the-fly verification, the firewall would terminate both sides of the connection in case it sees an invalid block. That first occurrence of an invalid block would not be forwarded to the downloading party.

A log file can be parsed during download before the download is finished to defend against a common third party hack such as exploiting a log file parsers after a complete download. This defends against malicious modification of log file entries in databases or CDN's with the intent to remotely exploit management infrastructure parsing these logs. The storage does not need to be trusted in this case.

Files can be downloaded partially and still allow full verification of the partially downloaded part.

Continuous hashing is backwards compatible with a pre-existing file and third signature. The continuous hashing can be applied as a container format or as a web service API to allow verification of partial download against the third-party signature without recalculating the signature or adding a signature.

Continuous hashing can be applied to an untrusted content delivery network to enable downloads with continuous signature verification without re-signing the content.

Continuous hashing can be applied to a hardware engine for verifying a firmware image download in a single step starting at the first received block.

A further valuable use is as integrated into or closely coupled with a firewall. A firewall can be aware of a continuously hashing method including the continuous hashing container format. The (optionally transparent) firewall (or proxy) could incrementally let through push or pull requests of an IoT device in case the start of the container and subsequent blocks check out. An advantage of continuous hashing is that the firewall does not need to store the firmware download or parts of it as the firewall can verify the data flowing by in a streaming fashion. The interleaved hash states just need to be placed close to the point into the stream when the application firewall will verify them anyway. Today's firewall systems in avionics network security system store the whole image for signature verification before forwarding it to the more trusted side and this has either severe limitations on the firmware update (maximum firmware size) or on making the system resilient against DoS-attacks. Such approaches consume considerable resources are disadvantageous where firmware updates can easily be in the 10's or 100's of megabytes (Embedded Linux etc.).

In absence of the continuous hashing container format, a firewall can transparently attempt to fetch a corresponding continuous hashing manifest and the needed intermediated hashes in a separate file relative to the original file (manifest file already discussed). In case devices behind the application network firewall choose to use the continuing hashing method for downloading firmware, that download is not influenced by resource limitations on the application firewall and the update size. Assuming thousands of IoT devices behind that firewall being updated in parallel, resources used on the firewall will matter very much.

A further example are digitally signed files using the RSA method. Entity A sends a signed message to entity B using private key C. A produces a hash value of the message, raises it to the power of d (modulo n) (as when decrypting an RSA message), and attaches it as a “signature” to the message. B receives the signed message and uses the same hash algorithm in conjunction with public key D. B raises the signature to the power of e (modulo n) (as when encrypting a message for RSA), and compares the resulting hash value with the message's actual hash value. If the two agree, B knows that the author of the message was in possession of A's private key C, and that the message has not been tampered with since. In this context, a signature is a finalized hash state in that it takes a hash state and applies a finalizing process. In the case of RSA therefore the finalised hash would not need to be transmitted as part of the container—just the intermediate hash states minus the first hash state (which would be identical for all files using the same signature algorithm—the starting initial hash state). The container format therefore only would need a concept of size—which might be optionally inferred from other higher levels (think of http Content-Length field etc.) and therefore not part of the transmission, too. Essentially the RSA signature would be transmitted first before any of the block/intermediate hash transmissions.

A further example are files using Cryptographic Message Syntax (CMS) (RFC 5652). For RFC5652 the verbatim finalised hash is already part of the CMS container format, thus the finalised hash won't need to be transmitted independently. Simply speaking, the CMS container would be split into three parts: the part before the original signed payload; the signed payload; and the part after the signed payload. The first and third parts are transmitted before any parts of the payload and can be therefore verified upfront. The length of the payload needs to be transmitted or calculated from the higher level protocol length indicator (http content-length for an instance) as is not verbatim included in the CMS format. The length information therefore would be lost by stripping out the payload. The payload would be transmitted block by block, each block followed by the hash state at the start of that block.

On the receiving side the CMS message needs to be verified down to the signature of the hash value (with the payload stripped out) to validate the finalised hash value. Once the hash value is trusted, that is used to verify the last block (received first) and validate the starting state of the last block as a result. The length of the payload needs to be calculated or known. Each block is considered by: using the next hash state by running the hash algorithm over the last received block based on that hash state; and comparing this with the previous hash state. If hash states are identical then that block is trusted, stored to flash and the new start hash state becomes trusted and remembered for verifying the next block (turns into “last hash state”). This is continued until the first block is received (last block transmitted) and the hash state calculated over block to compare with the previous hash state (using the known initial hash state as starting condition). If both match then the image is completely verified.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Example C code instructions for creating a container are listed below with inline comments.

#include <stdlib.h>
#include <stdint.h>
#include <stdio.h>
#include <memory.h>
#include “hash/sha256.h”
#define BLOCK_SIZE (1024UL*128)
#define ARRAY_COUNT(x)(sizeof(x)/sizeof(x[0]))
#define MAX_BLOCK_COUNT 64
#define HASH_STATE_COUNT ARRAY_COUNT(((sha256_t*)NULL)−>state
typedef uint32_t t_hash_state[HASH_STATE_COUNT];
static t_hash_state g_block_hash_state[MAX_BLOCK_COUNT];
static uint8_t g_file_digest[SHA256_DIGEST_SIZE];
void print_digest(const uint8_t *digest)
{

int i;
fprintf(stderr, “sha256 digest: ”);
for(i=0; i<SHA256_DIGEST_SIZE; i++)

fprintf(stderr, “%02x”, *digest++);

fprintf(stderr, “\n”);

}
void print_hash_state(int block_index, int size, const t_hash_state *state)
{

int i;
fprintf(stderr, “Block[%03i]”, block_index);
for(i=0; i<HASH_STATE_COUNT; i++)

fprintf(stderr, “ 0x%08X”, (*state)[i]);

fprintf(stderr, “ (%i bytes) \n”, size);

}
uint32_t calculate_block_hash_states(FILE *file)
{

sha256_t hash;
uint32_t block, size, total_size;
static uint8_t block_buffer[BLOCK_SIZE];
/* Initialize hash state context variable */
sha256_init(&hash);
total_size = 0;
block = 0;
while(!feof(file))
{

if(block>=MAX_BLOCK_COUNT)

return 0;

/* remember hash state at start of block */
memcpy(g_block_hash_state[block], hash.state, sizeof(t_hash_state));
/* read new block from file */
size = fread(&block_buffer, 1, BLOCK_SIZE, file);
/* run hash over the block buffer */
sha256_update(&hash, block_buffer, size);
/* calculate total file size */
total_size += size;
/* increment block counter */
block++;

}
/* calculate final file digest */
sha256_final(&hash, g_file_digest);
/* print digest on console for debug purposes */
print_digest(g_file_digest);
return total_size;

}
int create_container(FILE *file, uint32_t file_size)
{

uint32_t block_size, block_index;
uint8_t block_buffer[BLOCK_SIZE];
t_hash_state *hash_state;
/* ignore empty files */
if(!file_size \\ file_size>(BLOCK_SIZE*MAX_BLOCK_COUNT))

return 1;

/* write total file size to beginning of container file */
fwrite(&file_size, 1, sizeof(file_size), stdout);
/* write file digest of complete file to container */
fwrite(g_file_digest, 1, sizeof(g_file_digest), stdout);
/* determine size of last block */
if(!(block_size = file_size % BLOCK_SIZE))

block_size = BLOCK_SIZE;

/* calculate block number */
block_index = (file_size − block_size)/BLOCK_SIZE;
/* write all blocks and hash states in reverse order to container */
while(1)
{

/* read block at block_index into buffer */
fseek(file, block_index*BLOCK_SIZE, SEEK_SET);
fread(block_buffer, 1, block_size, file);
/* output block to container file */
fwrite(block_buffer, 1, block_size, stdout);
/* get hash state for the start of the block read above */
hash_state = &g_block_hash_state[block_index];
/* output hash state at start of block */
fwrite(hash_state, 1, sizeof(*hash_state), stdout);
/* print state for debug purposes */
print_hash_state(block_index, block_size, hash_state);
/* all remaining blocks are of BLOCK_SIZE */
block_size = BLOCK_SIZE;
/* move one block back */
if(block_index)

block_index−−;

else

break;

}
return 0;

}
int main(int argc, char *argv[ ])
{

int res;
uint32_t file_size;
FILE *file;
if(!(file = fopen(“input.img”,“r”)))

exit(EXIT_FAILURE);

/* calculate all intermediate hashes and final digest for file */
file_size = calculate_block_hash_states(file);
/* output resulting container: all blocks in reverse order with
* intermediate hashes */
res = create_container(file, file_size);
if(res)

printf(“ERROR: %i\n”, res);

fclose(file);
return res;

}

Example C code instructions for verifying a container are listed below with inline comments.

#include <stdlib.h>
#include <stdbool.h>
#include <stdint.h>
#include <stdio.h>
#include <memory.h>
#include “hash/sha256.h”
#define BLOCK_SIZE (1024UL*128)
#define ARRAY_COUNT(x)(sizeof(x)/sizeof(x[0]))
#define MAX_BLOCK_COUNT 64
#define HASH_STATE_COUNT ARRAY_COUNT(((sha256_t*)NULL)−>state)
void print_digest(const uint8_t *digest)
{

int i;
fprintf(stderr, “sha256 digest: ”);
for(i=0; i<SHA256_DIGEST_SIZE; i++)

fprintf(stderr, “%02x”, *digest++);

fprintf(stderr, “\n”);

}
void print_hash_state(int block_index, int size, const uint32_t *state)
{

int i;
fprintf(stderr, “Block[%03i]”, block_index);
for(i=0; i<HASH_STATE_COUNT; i++)

fprintf(stderr, “ 0x%08X”, state[i]);

fprintf(stderr, “ (%i bytes) \n”, size);

}
int verify_container(FILE *file)
{

bool last_block;
uint32_t file_pos, block_size;
static uint8_t block_buffer[BLOCK_SIZE];
static uint8_t digest[SHA256_DIGEST_SIZE], digest_tmp[SHA256_DIGEST_SIZE];
uint32_t hash_state[HASH_STATE_COUNT],

hash_state_prev[HASH_STATE_COUNT];

sha256_t ctx;
/* read size of total file */
if(!fread(&file_pos, sizeof(file_pos), 1, file))

return 1;

if(file_pos>(BLOCK_SIZE*MAX_BLOCK_COUNT))

return 2;

printf(“file size: %u\n”,file_pos);
/* read digest of complete file */
if(!fread(digest, sizeof(digest), 1, file))

return 3;

print_digest(digest);
/* calculate size of first block */
if(!(block_size = file_pos % BLOCK_SIZE))

block_size = BLOCK_SIZE;

last_block = true;
while(file_pos && !feof(file))
{

/* read data block */
if(!fread(block_buffer, block_size, 1, file))

return 4;

/* read hash state for the beginning of the block above */
fread(hash_state, sizeof(hash_state), 1, file);
/* cadulate file position for start of block */
file_pos −= block_size;
/* print the hash state for the beginning of this block */
print_hash_state(file_pos / BLOCK_SIZE, block_size, hash_state);
/* synthesize hash context at start for this block */
sha256_init(&ctx);
/* update file position at start of block */
ctx.count = file_pos;
/* copy the hash state for the beginning of this block into
* state - from the hash state we read earlier */
memcpy(ctx.state, hash_state, sizeof(ctx.state));
/* run hash for this block with the synthesized hash */
sha256_update(&ctx, block_buffer, block_size);
/* last block needs different treatment - need to finalize hash */
if(last_block)
{

last_block = false;
/* finalize hash with the hash state calculated */
sha256_final(&ctx, digest_tmp);
/* check first block against finalized hash */
if(memcmp(digest_tmp, digest, sizeof(digest)))

return 5;

/* after this point we can trust the hash state ! */

}
else
{

/* compare hash state with hash state for next block */
if(memcmp(ctx.state, hash_state_prev, sizeof(ctx.state)))

return 6;

}
/* save previous hash state as it is
* the final state of the next hash block */
memcpy(hash_state_prev, hash_state, sizeof(hash_state_prev));
/* all remaining blocks are of BLOCK_SIZE */
block_size = BLOCK_SIZE;

}
return 0;

}
int main(int argc, char *argv[ ])
{

int res;
FILE *file;
/* open container file for verification */
if(!(file = fopen(“container.img”,“r”)))

exit(1);

/* verify container file */
res = verify_container(file);
if(res)

printf(“ERROR: %i\n”, res);

fclose(file);
return res;

}

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

1. A method for verifying part or all of a downloading file, the file comprising a sequence of bytes, one or more bytes defining a block, the file having one or more blocks and the file having a final hash state calculated by a hash algorithm over the one or more blocks in ascending order from first to last, each block of the one or more blocks having a starting hash state, said method comprising:
receiving the final hash state;
receiving the one or more blocks orderable in descending order starting from the last block;
receiving, for each received block, the starting hash state for that block;
calculating, for each received block, an ending hash state by running the hash algorithm from the starting hash state of the received block;
confirming the starting hash state for each received block when the ending hash state is the same as the final hash state or a confirmed starting hash state; and
flagging an error when an ending hash state does not match the final hash state or a confirmed starting hash state.

2. A method according to claim 1, further comprising, when the ending hash state does not match the final hash state or a confirmed starting hash state, ending the download and/or requesting retransmission of the download.

3. A method according to claim 1, further comprising verifying the file if the starting hash states are confirmed for the whole sequence of blocks.

4. method according to claim 1, further comprising verifying a partial file comprising only blocks with a confirmed starting hash state.

5. A method according to claim 1, further comprising receiving an indication of the size of the file.

6. A method according to claim 1, wherein a hash state is a signed with a private key.

7. A method according to claim 1, wherein a hash state is finalized for each block for verification as required by the hashing algorithm used before comparing it to a transmitted intermediate hash state.

8. A method according to claim 1, further comprising receiving each block and forwarding them to a device optionally with an individual confirmation.

9. (canceled)

10. A method according to claim 1, wherein a block of bytes and starting hash state are received together.

11. A method according to claim 1, wherein a plurality of starting hash states are received together.

12. (canceled)

13. A method according to claim 12, wherein an indication of the length of the file is received in a header file.

14. A system for verifying part or all of a downloading file, the file comprising a sequence of bytes, one or more bytes defining a block, the file having one or more blocks and the file having a final hash state calculated by a hash algorithm over the one or more blocks in ascending order from first to last, each block of the one or more blocks having a starting hash state, said system comprising:
a receiver to receive a final hash state configured to receive, the one or more blocks orderable in descending order starting from the last block, and to receive, for each received block, the starting hash state for that block; and
verification circuitry to calculate for each received block, an ending hash state by running the hash algorithm from the starting hash state of the received block; for confirming the starting hash state for each received block when the ending hash state is the same as the final hash state or a confirmed starting hash state, and to flag an error when an ending hash state does not match the final hash state or a confirmed starting hash state.

15. A system according to claim 14, wherein the verification circuitry is further configured to, when the ending hash state does not match the final hash state or a confirmed starting hash state, end the download and/or request retransmission of the download.

16. A system according to claim 14, wherein the verification circuitry is further configured to confirm the file if the starting hash states are confirmed for the whole sequence of blocks.

17. (canceled)

18. A system according to claim 14, wherein a hash state is a signed with a private key.

19. A system according to claim 14, wherein a hash state is finalized for each block for verification as required by the hashing algorithm used before comparing it to a transmitted intermediate hash state.

20. (canceled)

21. (canceled)

22. A system according to claim 14, wherein a block of bytes and starting hash state are received together.

23. A system according to claim 22, wherein a plurality of starting hash states are received together.

24. A system according to claim 14, wherein a plurality of starting hash states are received together in a header file.

25. (canceled)

26. (canceled)

27. A computer program for verifying part or all of a downloading file, the file comprising a sequence of bytes, one or more bytes defining a block, the file having one or more blocks, the file having a final hash state calculated by a hash algorithm over the one or more blocks in ascending order from first to last, each block of the one or more blocks having a starting hash state, the computer program stored on a non-transitory, computer-readable medium and loadable into an internal memory of a digital computer, wherein the computer program, when run on the digital computer, causes the digital computer to perform the following steps:
receiving the final hash state;
receiving the one or more blocks orderable in descending order starting from the last block;
receiving, for each received block, the starting hash state for that block;
calculating, for each received block, an ending hash state by running the hash algorithm from the starting hash state of the received block;
confirming the starting hash state for each received block when the ending hash state is the same as the final hash state or a confirmed starting hash state; and
flagging an error when an ending hash state does not match the final hash state or a confirmed starting hash state.
